(19) United States
(12) Patent Application Publication
(10) Pub. No.: US 2020/0195893 A1
(43) Pub. Date: Jun. 18, 2020

(54) REMOTE MONITORING SYSTEM AND MONITORING SERVER

(71) Applicant: TOYOTA JIDOSHA KABUSHIKI KAISHA, Aichi-ken (JP)

(72) Inventors: Ryohei OBARA, Nagakute-shi (JP); Masaki ITO, Toyota-shi (JP); Makoto KAKUCHI, Toyota-shi (JP); Mutsumi MATSUURA, Okazaki-shi (JP); Hiroaki SUGIYAMA, Nagoya-shi (JP); Yuichi TASHIRO, Owariasahi-shi (JP)

(21) Appl. No.: 16/597,870

(22) Filed: Oct. 10, 2019

(30) Foreign Application Priority Data
Dec. 17, 2018 (JP) 2018-235519

(51) Int. Cl. H04N 7/18; G06K 9/00; G06K 9/62; G08B 7/06; G05D 1/00; G05D 1/02

(52) U.S. Cl. CPC H04N 7/185; G06K 9/00771; G06K 9/6202; G05D 2201/0213; G05D 1/0094; G05D 1/0212; G08B 7/06

(57) ABSTRACT

In a monitoring area such as a resort house area that a user cannot directly monitor, a vehicle owned by the user performs patrol driving to capture an image of a surrounding state and transmits the image to a user terminal and a monitoring server as imaging data. The monitoring server analyzes the imaging data transmitted from the vehicle to determine whether an abnormality occurs in the monitoring area or not, and notifies the user terminal and the vehicle of a determination result. When the vehicle receives an abnormality notice from the monitoring server, the vehicle notifies outside that the abnormality occurs by light or sound.

### INCORPORATION BY REFERENCE

The disclosure of Japanese Patent Application No. 2018-235519 filed on Dec. 17, 2018 including the specification, drawings and abstract is incorporated herein by reference in its entirety.

### BACKGROUND

### 1. Technical Field

The present disclosure relates to a remote monitoring system and a monitoring server.

### 2. Description of Related Art

It is a fact that resort houses built in resorts and the like are used a lot during the season but are barely used during the off season. In view of such a fact, there has been proposed a method in which, while an owner does not use a resort house, an administrator different from the owner manages the resort house, so that the resort house is utilized (e.g., see Japanese Unexamined Patent Application Publication No. 2008-027311 (JP 2008-027311 A)).

### SUMMARY

However, the method in the related art has such a problem that maintenance and management of the resort house largely depend on the administrator, and it is difficult for the owner to grasp the state of the resort house in real time.

The present disclosure is accomplished in view of the circumstances described above, and an object of the present disclosure is to provide a technology that can grasp the state of a remote area including a resort house in real time.

A remote monitoring system according to one aspect of the present disclosure is a remote monitoring system including a movable body, and a monitoring server configured to monitor a predetermined area by use of the movable body. The movable body includes: a travel portion configured to perform patrol driving in the predetermined area in accordance with an instruction from the monitoring server; an imaging portion configured to capture an image of the predetermined area and output imaging data; and a transmission portion configured to transmit the imaging data to the monitoring server. The monitoring server includes: a reception portion configured to receive the imaging data from the movable body; an acceptance portion configured to accept, from an information terminal of a user, an instruction for the patrol driving in the predetermined area by the movable body; and a transmission portion configured to transmit the instruction to the movable body and transmit the imaging data received from the movable body to the information terminal of the user.

A monitoring server according to another aspect of the present disclosure is a monitoring server for monitoring a predetermined area by use of a movable body including an imaging portion. The monitoring server includes: a reception portion configured to receive imaging data of the predetermined area from the movable body performing patrol driving in the predetermined area, the imaging data being output from the imaging portion; an acceptance portion configured to accept, from an information terminal of a user, an instruction for the patrol driving by the movable body in the predetermined area; and a transmission portion configured to transmit the instruction to the movable body and transmit the imaging data received from the movable body to the information terminal of the user.

With the present disclosure, it is possible to grasp the state of a remote area including a resort house in real time.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a view illustrating an exemplary system configuration of a remote monitoring system according to the present embodiment;

FIG. 2 is a view illustrating one example of a device configuration of a monitoring server;

FIG. 3 is a view illustrating a registration content of a vehicle management table;

FIG. 4 is a view illustrating a registration content of a route map management table;

FIG. 5 is a view illustrating a concrete example of a route pattern;

FIG. 6 is a view illustrating one example of a device configuration of a vehicle;

FIG. 7 is a flowchart illustrating a patrol driving process flow;

FIG. 8 is a flowchart illustrating an analysis process flow; and

FIG. 9 is a flowchart illustrating an abnormality notification process flow.

### DETAILED DESCRIPTION OF EMBODIMENTS

With reference to the attached drawings, the following describes a preferred embodiment of the present disclosure. Note that, in each figure, members having the same reference sign have the same or similar configuration.

### A. Present Embodiment

A-1. Configuration

System Configuration

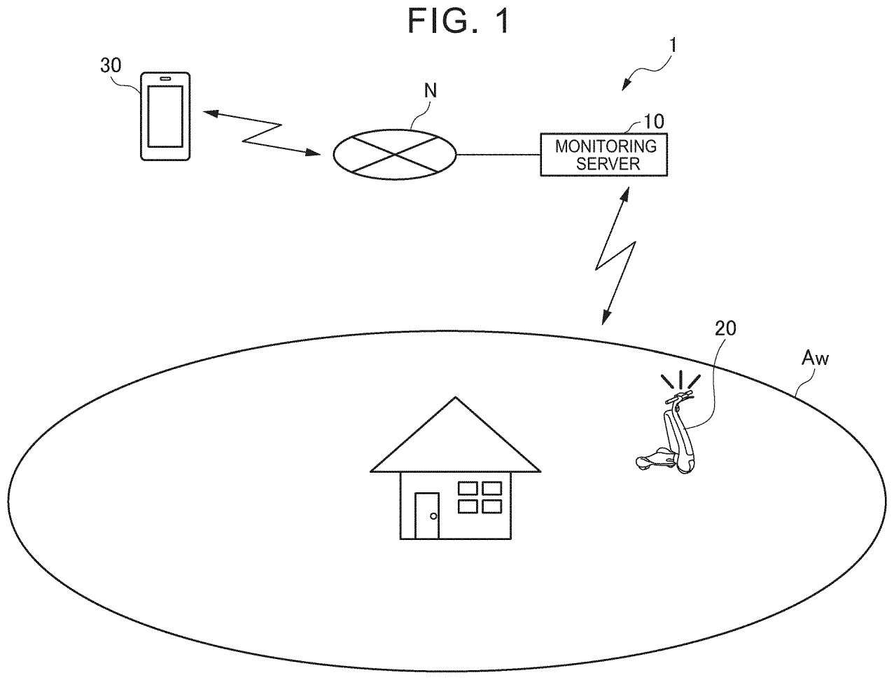

FIG. 1 is a view illustrating an exemplary system configuration of a remote monitoring system 1 according to the present embodiment. The remote monitoring system 1 includes a monitoring server 10, a vehicle 20 going around a monitoring area Aw, and a user terminal 30. The control device 11, the vehicle 20, and the user terminal 30 can communicate with each other by wireless communication via a communication network N.

The monitoring area Aw is an area where a user performs remote monitoring by use of the vehicle 20. An example of the monitoring area Aw is a resort house area owned by the user, and the like. Since it is difficult to directly monitor the resort house area on weekdays or the like, the user performs remote monitoring by use of the vehicle 20 stationed in the resort house area.

The monitoring area Aw is not limited to the resort house area or the like and can be set in various facilities having a large site, e.g., a commercial facility such as a shopping mall, an amusement facility, a theme park, a playground, a baseball stadium, and so on. Further, in FIG. 1, since the resort house area is assumed as the monitoring area Aw, one user, one vehicle 20, and one user terminal 30 are illustrated. However, the number of users, the number of vehicles 20, and the number of user terminals 30 can be optionally set in accordance with a target monitoring area Aw or the like.

The monitoring server 10 is a server configured to control patrol driving or the like of the vehicle 20 stationed in the monitoring area Aw. The monitoring server 10 has a function to instruct the vehicle 20 to perform patrol driving in the monitoring area Aw and capture an image of a surrounding state so as to acquire imaging data, in accordance with an instruction, of the user, transmitted from the user terminal 30.

The vehicle 20 is an ultra lightweight vehicle and is stationed in a parking space or the like in the resort house area, for example. The vehicle 20 is equipped with a large-capacity battery and moves mainly by power of a motor. Further, the vehicle 20 is also provided with an imaging device configured to capture an image of a surrounding state.

In the present embodiment, an ultra lightweight vehicle that the user personally owns is assumed as the vehicle 20, but the vehicle 20 may be a sharing-type ultra lightweight vehicle rented to a community resident from a public organization (a city, a prefecture, and the like) having jurisdiction over an area including the monitoring area Aw, a company that operates in an area including the monitoring area Aw, or the like.

The user terminal 30 is a terminal operated by the user using the remote monitoring system 1 and is a smartphone, a tablet terminal, a portable terminal, or a notebook computer, or the like, for example. An application program (hereinafter referred to as “monitoring application”) necessary to use the remote monitoring system 1 is installed in the user terminal 30. The user performs remote monitoring in the monitoring area Aw by use of the vehicle 20 by starting the monitoring application.

Device Configuration of Monitoring Server

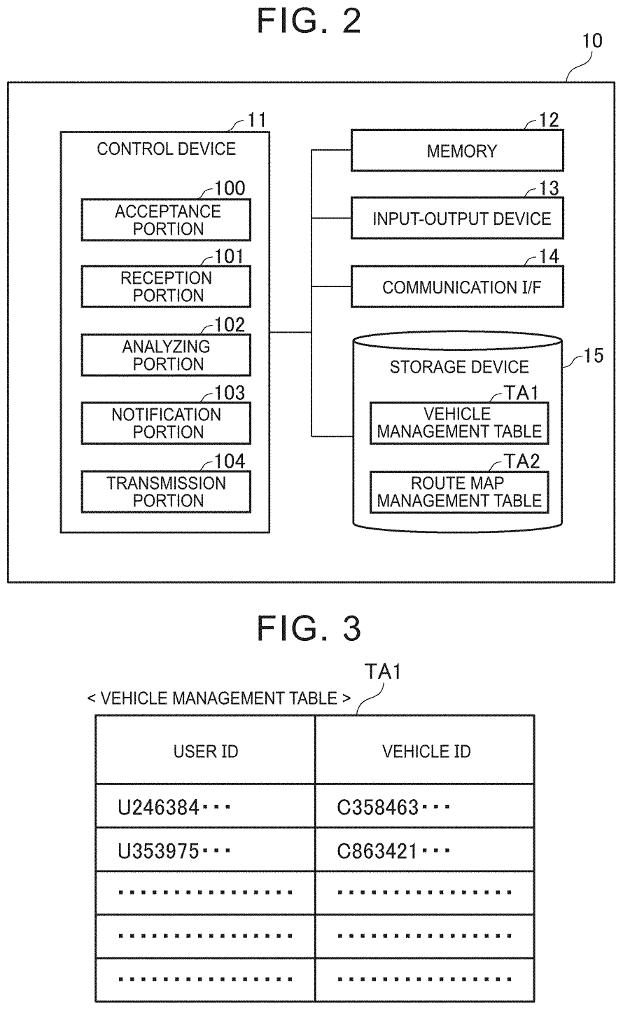

FIG. 2 is a view illustrating one example of a device configuration of the monitoring server 10. The monitoring server 10 implements a function and/or a method described in the present embodiment in collaboration with the control device 11, a memory 12, an input-output device 13, a communication I/F 14, and a storage device 15.

The control device 11 executes a function and/or a method implemented by a code or an order included in a program stored in the memory 12 or the like. The control device 11 includes, for example, a central processing unit (CPU), a micro processing unit (MPU), a GPU, a microprocessor, a processor core, a multiprocessor, an application-specific integrated circuit (ASIC), a field programmable gate array (FPGA), and so on.

A program loaded from the storage device 15 is temporarily stored in the memory 12 so as to provide a working area to the control device 11. Various pieces of data generated while the control device 11 executes the program are also temporarily stored in the memory 12. The memory 12 includes, for example, a random access memory (RAM), a read only memory (ROM), and the like.

The input-output device 13 includes an input device (a keyboard, a touch panel, a mouse, a microphone, or the like) into which various operations to the monitoring server 10 are input, and an output device (a display, a speaker, or the like) configured to output results of processes performed by the monitoring server 10.

The communication I/F 14 transmits and receives various pieces of data via the communication network N. The communication may be performed by wired communication or wireless communication, and any communication protocol may be used, provided that mutual communication can be performed. The communication I/F 14 has a function to perform communication with the vehicle 20 and the user terminal 30 via the communication network N. The communication I/F 14 transmits various pieces of data to the vehicle 20 and the user terminal 30 in accordance with an instruction from the control device 11.

For example, the storage device 15 is constituted by a hard disk drive (HDD), a solid state drive (SSD), a flash memory, and so on and includes a vehicle management table TA1 and a route map management table TA2.

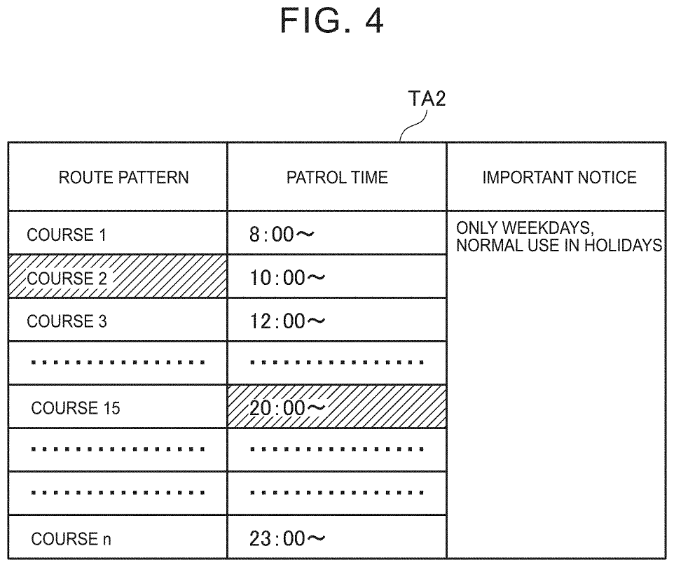

FIG. 3 is a view illustrating a registration content of the vehicle management table TA1, and FIG. 4 is a view illustrating a registration content of the route map management table TA2. As illustrated in FIG. 3, in the vehicle management table TA1, a user ID to uniquely specify a user who owns the vehicle 20 and a vehicle ID to specify the vehicle 20 are stored in association with each other. As an example of the user ID, a terminal ID of the user terminal 30, a phone number, or the like may be used.

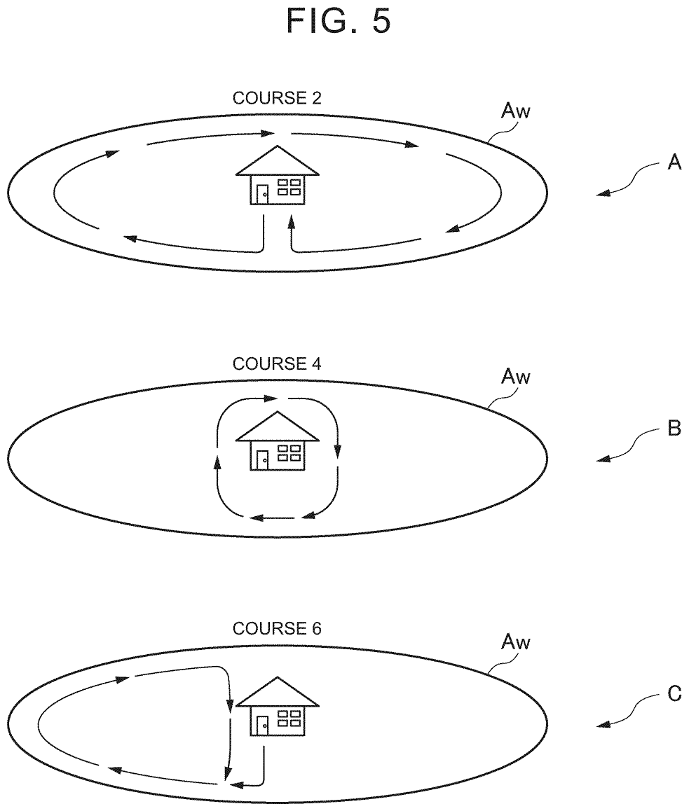

As illustrated in FIG. 4, in the route map management table TA2, a plurality of route patterns selectable by the user, and a plurality of patrol times, and important notices are stored. Here, “route pattern” is map information indicative of a patrol driving pattern of the vehicle 20 in the monitoring area Aw, and various patterns can be set as illustrated in A to C in FIG. 5, for example.

The example illustrated in FIG. 4 illustrates a case where “COURSE 2” (see a shaded part) is selected by the user as a route pattern, “FROM 20:00” (see a shaded part) is selected by the user as a patrol time, and “ONLY WEEKDAYS, NORMAL USE IN HOLIDAYS” is registered as an important notice. The user operates the user terminal 30 appropriately so as to select the route pattern and the patrol time and to input the important notice.

Referring back to FIG. 2, an acceptance portion 100, a reception portion 101, an analyzing portion 102, a notification portion 103, and a transmission portion 104 can be implemented by the control device 11 executing a program stored in the memory 12 or the like. Further, the program can be stored in a storage medium. The storage medium in which the program is stored may be a non-transitory computer readable medium. The non-transitory medium is not limited particularly but may be a storage medium such as a USB memory or a CD-ROM.

The acceptance portion 100 has a function to accept an instruction related to patrol driving by the vehicle 20 in the monitoring area Aw (a route pattern, a patrol time, an important notice, and the like) from the user terminal 30 and register the instruction in the route map management table TA2.

The reception portion 101 has a function to receive, from the vehicle 20, imaging data indicative of an image of a surrounding state that is captured during the patrol driving and sequentially store the imaging data in the storage device 15.

The analyzing portion 102 has a function to analyze the imaging data thus received and determine whether an abnormality occurs in the monitoring area Aw or not (intrusion by suspicious person, intrusion by wild bird and beast, occurrence of suspicious fire, destruction of building or the like, and so on). As an example of an analyzing method, there is a method in which it is determined whether an abnormality occurs in the monitoring area Aw or not by comparing past imaging data (that is, history data) received from the vehicle 20 with imaging data received this time, for example, but the present disclosure is not limited to this.

The notification portion 103 has a function to notify the user terminal 30 and the vehicle 20 of an analysis result (whether an abnormality occurs or not, an abnormality type, and the like) of the imaging data analyzed by the analyzing portion 102. Here, “abnormality type” includes intrusion by suspicious person, occurrence of suspicious fire, destruction of building or the like, and so on. When the notification portion 103 notifies the user terminal 30 that an abnormality occurs, in order to surely notify the user that an emergency event occurs, the notification portion 103 instructs a beep or a vibration to be generated at the same timing as the notification, for example.

The transmission portion 104 has a function to transmit, to the vehicle 20, an instruction (hereinafter referred to as “patrol instruction”) related to patrol driving in the monitoring area Aw, the instruction being received from the user terminal 30, and to transmit the imaging data received from the vehicle 20 to the user terminal 30.

Note that the imaging data thus received from the vehicle 20 may be transmitted in response to a request from the user terminal 30. For example, the imaging data may be transmitted to the user terminal 30 every 30 minutes, or in a case where the analyzing portion 102 determines that an abnormality occurs in the monitoring area Aw, the imaging data acquired at this time may be transmitted to the user terminal 30.

Device Configuration of Vehicle

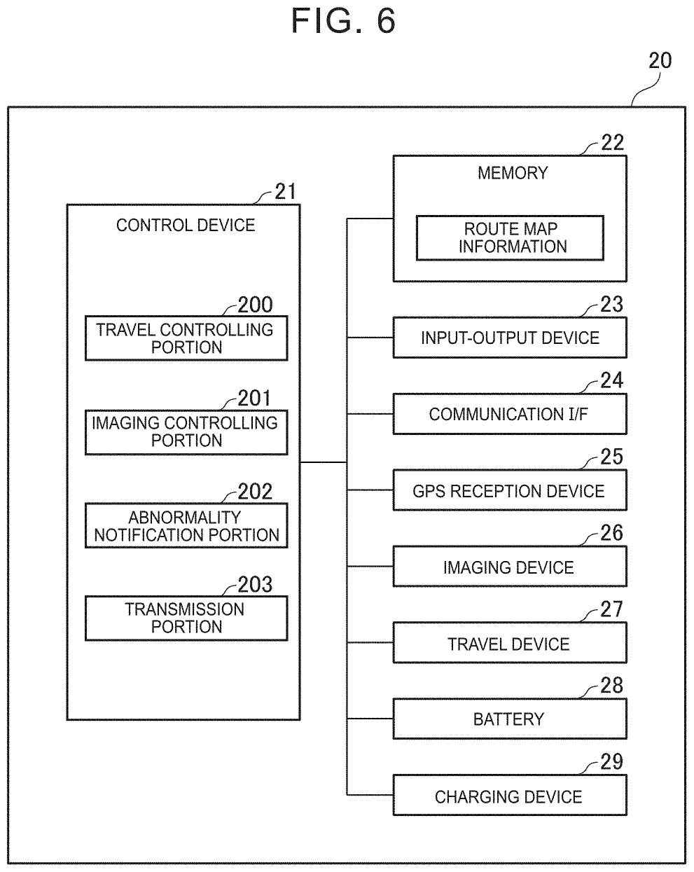

FIG. 6 is a view illustrating an example of a device configuration of the vehicle 20. The vehicle 20 includes a control device 21, a memory 22, an input-output device 23, a communication I/F 24 configured to communicate with the monitoring server 10, a GPS receiving device 25 configured to receive a signal from a GPS satellite, an imaging device 26, a travel device 27, a battery 28, and a charging device 29. FIG. 6 illustrates a necessary configuration of the vehicle 20 to describe the embodiment, and the vehicle 20 also includes devices or the like not illustrated in FIG. 6.

Route map information including the route pattern, the patrol time, and the important notice indicated by the user, and the like are registered in the memory 22.

The input-output device 23 includes an input device (a touch panel, a microphone, or the like), and an output device (a display, a flash light, a speaker, or the like) configured to output information.

The imaging device (imaging portion) 26 is constituted by a camera (a digital camera, a video camera, or the like) including an image sensor and is configured to capture an image of a surrounding state of the monitoring area Aw during patrol driving and output imaging data.

The travel device (travel portion) 27 is constituted by various devices such as tires, a motor, and a gear that are necessary to drive the vehicle 20. The battery 28 supplies electric power necessary for the travel device 27 to drive the vehicle 20. The charging device 29 is a device configured to charge the battery 28 upon receipt of electric power supplied from an external power source.

A travel controlling portion 200, an imaging controlling portion 201, an abnormality notification portion 202, and a transmission portion 203 can be implemented by the control device 21 of the vehicle 20 executing a program stored in the memory 22. Further, the program can be stored in a storage medium. The storage medium in which the program is stored may be a non-transitory computer readable medium. The non-transitory medium is not limited particularly but may be a storage medium such as a USB memory or a CD-ROM.

The travel controlling portion (travel portion) 200 has a function to control patrol driving by the vehicle 20 in the monitoring area Aw in accordance with a patrol instruction transmitted from the monitoring server 10. For example, in a case where a patrol instruction including a route pattern of “COURSE 2” (see A in FIG. 5) is received from the monitoring server 10, the travel controlling portion 200 reads out route map information corresponding to “COURSE 2” from the memory 22 and controls the patrol driving of the vehicle 20.

The imaging controlling portion (imaging portion) 201 has a function to control the capturing of an image of a surrounding state of the monitoring area Aw by the imaging device 26 in accordance with start and stop of the patrol driving, or the like.

The abnormality notification portion 202 has a function to notify outside that an abnormality occurs, by light or sound, when the abnormality notification portion 202 receives an abnormality notice (that is, a notice of an analysis result indicative of the occurrence of an abnormality in the monitoring area Aw and an abnormality type) from the monitoring server 10. For example, in a case where the abnormality notification portion 202 receives an abnormality notice indicating that intrusion by a suspicious person into the monitoring area Aw has been acknowledged, the abnormality notification portion 202 performs a control such as flashing of a flash light, ringing of an alarm bell, or making of a firing sound of a gun from a speaker, in order to threaten the suspicious person. Note that lighting of the flash light, a type and a volume of a sound emitted from the speaker, or the like should be set appropriately in accordance with the abnormality type to be notified.

The transmission portion 203 has a function to transmit imaging data output from the imaging device 26 to the monitoring server 10.

A-2. Operation

Patrol Driving Process

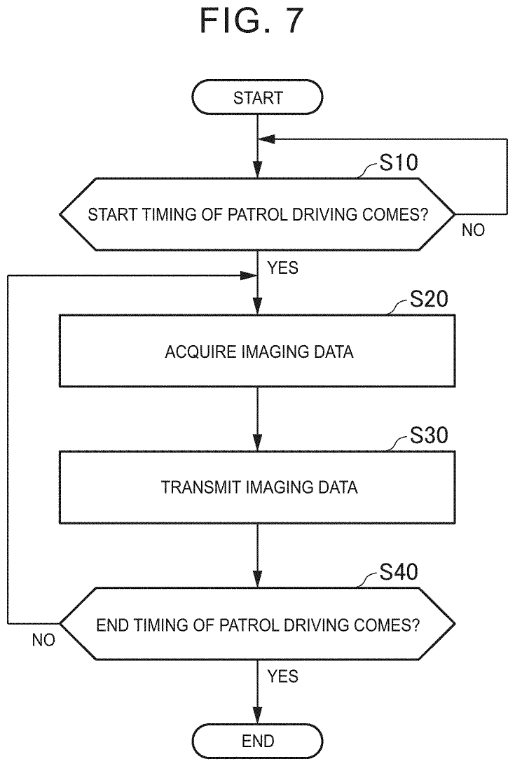

FIG. 7 is a flowchart illustrating a patrol driving process flow executed by the control device 21 of the vehicle 20. Note that, in the following description, it is assumed that the user starts the monitoring application installed in the user terminal 30 so as to select a route pattern and a patrol time and to input an important notice (see FIG. 4). When the selection and the input are performed, route map information including the selected route pattern, the patrol time, and the important notice is transmitted from the monitoring server 10 to the vehicle 20 and stored in the memory 22.

The travel controlling portion 200 refers to the route map information stored in the memory 22 and determines whether a start timing of the patrol driving comes or not (step S10). When the travel controlling portion 200 determines that the start timing of the patrol driving has not come yet (step S10; NO), the travel controlling portion 200 executes step S10 repeatedly.

In the meantime, when a current time is the same as the patrol time, and therefore, the travel controlling portion 200 determines that the start timing of the patrol driving has come (step S10; YES), the travel controlling portion 200 starts the patrol driving in accordance with the route pattern. The imaging controlling portion 201 starts capturing an image of the surrounding state of the monitoring area Aw by the imaging device 26 in accordance with the start of the patrol driving and acquires imaging data (step S20). The imaging controlling portion 201 transmits the imaging data thus acquired by the imaging device 26 to the transmission portion 203. The transmission portion 203 transmits the imaging data output from the imaging device 26 to the monitoring server 10 (step S30).

The travel controlling portion 200 refers to the route map information and determines whether an end timing of the patrol driving has come or not (step S40). When a current vehicle position is a halfway point of the route pattern and has not reached a destination point yet, and therefore, the travel controlling portion 200 determines that the end timing of the patrol driving has not come yet (step S40; NO), the travel controlling portion 200 returns to step S20 and executes a series of the processes described above repeatedly.

After that, when the current vehicle position has reached the destination point of the route pattern, and therefore, the travel controlling portion 200 determines that the end timing of the patrol driving has come (step S40; YES), the travel controlling portion 200 ends the process.

Analysis Process

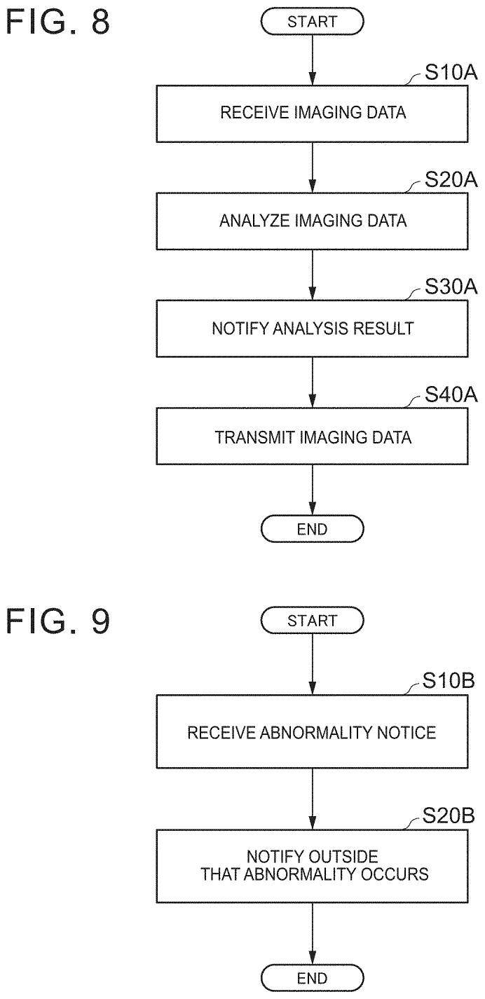

FIG. 8 is a flowchart illustrating an analysis process flow executed by the control device 11 of the monitoring server 10.

When the reception portion 101 receives imaging data indicative of an image of a surrounding state, captured during the patrol driving, from the vehicle 20, the reception portion 101 stores the imaging data in the storage device 15 sequentially (step S10A). The analyzing portion 102 analyzes the received imaging data (step S20A) and determines whether an abnormality (intrusion by suspicious person, intrusion by wild bird and beast, occurrence of suspicious fire, destruction of building or the like, and so on) occurs in the monitoring area Aw or not. The notification portion 103 notifies the user terminal 30 and the vehicle 20 of an analysis result (whether an abnormality occurs or not, an abnormality type, and the like) of the imaging data analyzed by the analyzing portion 102. Note that, when the notification portion 103 determines that no abnormality occurs, the notification portion 103 may not notify the user terminal 30 and the vehicle 20 of the analysis result indicating that no abnormality occurs. In the meantime, the transmission portion 104 transmits, to the user terminal 30, the imaging data received by the reception portion 101 in step S10A and ends the process.

Abnormality Notification Process

FIG. 9 is a flowchart illustrating an abnormality notification process flow executed by the control device 21 of the vehicle 20. When the abnormality notification portion 202 receives an abnormality notice (that is, a notice including an analysis result indicative of the occurrence of an abnormality in the monitoring area Aw and an abnormality type) from the monitoring server 10 (step S10B), the abnormality notification portion 202 notifies outside that the abnormality occurs by light or sound (step S20B) and ends the process.

As described above, in the present embodiment, in a monitoring area such as a resort house area that the user cannot directly monitor on weekdays or the like, the vehicle owned by the user performs patrol driving. The vehicle captures an image of a surrounding state during the patrol driving and transmits the image to the user terminal and the monitoring server as imaging data. The user can grasp the surrounding state of the monitoring area or the like in real time by checking the imaging data.

Further, the monitoring server analyzes the imaging data transmitted from the vehicle and determines whether an abnormality occurs in the monitoring area or not, and notifies the user terminal and the vehicle of a determination result. When the vehicle receives an abnormality notice from the monitoring server, the vehicle notifies outside that the abnormality occurs by light or sound. For example, in a case where the detected abnormality is intrusion by a suspicious person or the like, the flash light is flashed to threaten the suspicious person or the like, thereby making it possible to minimize a damage caused due to the occurrence of the abnormality.

### B. Modification

The embodiment described above is intended to facilitate understanding of the present disclosure and is not intended to interpret the present disclosure in a limitative manner. The flowcharts and sequences described in the embodiment and each element provided in the embodiment and its arrangement, material, condition, shape, size, and the like are not limited to those described herein and can be changed appropriately. Further, the configurations described in different embodiments can be partially replaced or combined.

For example, the present embodiment illustrates a case where the route pattern and so on are registered in the memory 22 of the vehicle 20. However, the route pattern may be registered by use of positional information acquired by the GPS receiving device 25 provided in the vehicle 20, for example.

Further, the analyzing portion 102 of the monitoring server 10 analyzes the imaging data and determines whether an abnormality occurs in the monitoring area Aw or not. In addition to this, the analyzing portion 102 may analyze the imaging data to generate recommendation information indicative of an action to be taken by the user subsequently. For example, in a case where it is determined, from the imaging data, that weeds grow in the monitoring area Aw, the analyzing portion 102 generates recommendation information that suggests mowing of the weeds. The notification portion 103 notifies the user terminal 30 of the recommendation information generated by the analyzing portion 102. Note that, in a case where the vehicle 20 has a mowing function, the analyzing portion 102 may generate a mowing instruction to mow the weeds by the vehicle 20. In this case, the notification portion 103 should notify the vehicle 20 of the mowing instruction generated by the analyzing portion 102. In such a configuration, even without an instruction from the user, the vehicle 20 automatically performs mowing of the weeds, so that the monitoring area Aw can be managed in a preferable state. Of course, the action to be taken by the user subsequently is not limited to mowing. This configuration is applicable to every action including repair of a product in the monitoring area Aw, for example.

Further, in the embodiment, the vehicle 20 is not limited to an ultra lightweight vehicle. The vehicle 20 may be any vehicle, provided that the vehicle is provided with the imaging device 26.

Further, at least some of the processes in the monitoring server 10 may be implemented by cloud computing constituted by one or more computers. At least some of the processes in the monitoring server 10 may be performed by other computers. In this case, at least some of the processes of function parts implemented by the control device 11 may be performed by other computers. Further, the vehicle 20 may execute some of (or all of) the processes executed by the monitoring server 10.

What is claimed is:

1. A remote monitoring system comprising:
a movable body; and
a monitoring server configured to monitor a predetermined area by use of the movable body, wherein:
the movable body includes
a travel portion configured to perform patrol driving in the predetermined area in accordance with an instruction from the monitoring server,
an imaging portion configured to capture an image of the predetermined area and output imaging data, and
a transmission portion configured to transmit the imaging data to the monitoring server; and
the monitoring server includes
a reception portion configured to receive the imaging data from the movable body,
an acceptance portion configured to accept, from an information terminal of a user, an instruction for the patrol driving in the predetermined area by the movable body, and
a transmission portion configured to transmit the instruction to the movable body and transmit the imaging data received from the movable body to the information terminal of the user.

2. The remote monitoring system according to claim 1, wherein the monitoring server includes an analyzing portion configured to analyze the imaging data, and a notification portion configured to notify the movable body of an analysis result of the imaging data.

3. The remote monitoring system according to claim 2, wherein:
the analyzing portion analyzes the imaging data to determine whether an abnormality occurs in the predetermined area or not;
when the analyzing portion determines that the abnormality occurs, the notification portion sends, to the movable body, a notice that the abnormality occurs as the analysis result of the imaging data; and
the movable body further includes a notification portion configured to receive the notice from the monitoring server and notify outside that the abnormality occurs by light and/or sound.

4. The remote monitoring system according to claim 3, wherein the analyzing portion determines whether the abnormality occurs in the predetermined area or not, by comparing past imaging data received from the movable body with imaging data received this time.

5. The remote monitoring system according to claim 2, wherein the notification portion notifies the movable body and the information terminal of the user of the analysis result of the imaging data.

6. The remote monitoring system according to claim 5, wherein:
the monitoring server receives, from the information terminal of the user, a selection instruction to select a route pattern indicative of a travel route for the movable body; and
the monitoring server transmits, to the movable body, route map information including the selected route pattern in accordance with the selection instruction thus received.

7. A monitoring server for monitoring a predetermined area by use of a movable body including an imaging portion, the monitoring server comprising:
a reception portion configured to receive imaging data of the predetermined area from the movable body performing patrol driving in the predetermined area, the imaging data being output from the imaging portion;
an acceptance portion configured to accept, from an information terminal of a user, an instruction for the patrol driving by the movable body in the predetermined area; and
a transmission portion configured to transmit the instruction to the movable body and transmit the imaging data received from the movable body to the information terminal of the user.
